(19) United States
(12) Patent Application Publication
(10) Pub. No.: US 2014/0028566 A1
(43) Pub. Date: Jan. 30, 2014

(54) SYSTEMS AND METHODS FOR GENERATING A DYNAMIC AND LOCALIZED ATM KEYPAD

(71) Applicant: Infosys Limited, Bangalore (IN)

(72) Inventor: Atul Gupta, Pune (IN)

(73) Assignee: Infosys Limited, Bangalore (IN)

(21) Appl. No.: 13/954,940

(22) Filed: Jul. 30, 2013

(30) Foreign Application Priority Data
Jul. 30, 2012 (IN) 3126/CHE/2012

(51) Int. Cl. G06F 3/023

(52) U.S. Cl. CPC G06F 3/023
USPC 345/168

(57) ABSTRACT

The invention relates to a system and method for generating a dynamic and localized keypad in an automated teller machine (ATM). This invention involves receiving the language of preference information of the ATM users and retrieve the number values, texts and all other characters which are required to be displayed in the dynamic keypad. Based on the retrieved information the dynamic keypad is generated in the preferred language.

### RELATED APPLICATION DATA

This application claims priority to India Patent Application No. 3126/CHE/2012, filed Jul. 30, 2012, the disclosure of which is hereby incorporated by reference in its entirety.

### FIELD OF THE INVENTION

The present invention relates generally to generating a dynamic keypad, and in particular, to a system and method for generating a dynamic and localized keypad of automated teller machine (ATM).

### BACKGROUND

Automated teller machines (ATMs) are existing world over today. Most of these are English driven with some providing support for speech or screen display in localized language, but the hardware keys to enter information like pin, numeric data is typically only in English. Even if the keypad is available in local language, it is still a fixed keypad and not possible to change based on user operating it.

The limitation of existing technologies is that the people who are not familiar with English or not familiar with English numeric, cannot easily operate the ATM machines. Even if the keypad numbers are displayed in local language, they are still restrictive in that they can work with only one language at a time.

In view of the foregoing discussion, there is a need for a ATM keypad which can be dynamically loaded in different local languages.

### SUMMARY

The present invention overcomes the limitation mentioned above by generating a dynamic ATM keypad based on the user's language of preference. This invention makes the ATM interaction more user friendly for those people who are not familiar with English numeric.

According to the present embodiment, a method for generating a dynamic and localized keypad in an automated teller machine (ATM) is disclosed. The method includes receiving a language of preference of one or more ATM users interacting with the ATM machine. After that, the ATM machine retrieves a plurality of number values and texts which will be displayed in the keypad in the preferred language from a repository. In accordance with an embodiment of the present invention, the repository stores one or more languages and a plurality of number values and texts for the one or more languages. After retrieving the plurality of number symbols and texts, ATM machine generate a dynamic keypad in the preferred language and loads the dynamic keypad on a touch sensitive display of the ATM machine.

In an additional embodiment, a system for generating a dynamic and localized keypad in an automated teller machine (ATM) is disclosed. The system includes a language of preference information retrieving module, a repository, a preferred language retrieving module, and a dynamic keypad generation module. The language of preference information receiving module is configured to receive information related to a language of preference of one or more ATM users for a transaction. The repository is configured to store one or more languages and a plurality of number symbols for the one or more languages. The preferred language retrieving module is configured to retrieve the plurality of number symbols and texts in the preferred language from the repository, and the dynamic keypad generation module is configured to generate a dynamic keypad based on the preferred language, wherein the dynamic keypad is loaded on a touch sensitive display of the automated teller machine.

In another embodiment, a computer program product for generating a dynamic and localized keypad in an automated teller machine (ATM) is disclosed. The computer program product includes a computer usable medium having a computer readable program code embodied therein for generating a dynamic and localized keypad in an automated teller machine (ATM). The computer readable program code storing a set of instructions configured for receiving information related to a language of preference of one or more ATM users for a transaction, retrieving a plurality of number symbols and texts in the preferred language from a repository which are required to be displayed, wherein the repository stores one or more languages and a plurality of number symbols for the one or more languages and generating a dynamic keypad based on the preferred language, wherein the dynamic keypad is loaded on a touch sensitive display of the automated teller machine.

### BRIEF DESCRIPTION OF THE DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a block diagram illustrating a system for generating a dynamic and localized keypad in an automated teller machine (ATM), in accordance with an embodiment of the present invention.

FIG. 3 is an exemplary dynamically loaded keypad when the preferred language is English.

FIG. 4 is an exemplary dynamically loaded keypad when the preferred language is Marathi.

FIG. 5 is a flowchart, illustrating a method for generating a dynamic and localized keypad in an automated teller machine (ATM), in accordance with an embodiment of the present invention.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present disclosure provide a system and method for generating a dynamic and localized keypad in an automated teller machine (ATM). This involves receiving a language of preference of the ATM users and accordingly retrieving the number values and texts which are required to be displayed in the keypad from a repository which stores a number of languages and the number symbols for those languages. After retrieving the preferred language the ATM machine generates a dynamic keypad and loads it on a touch sensitive display of the ATM machine.

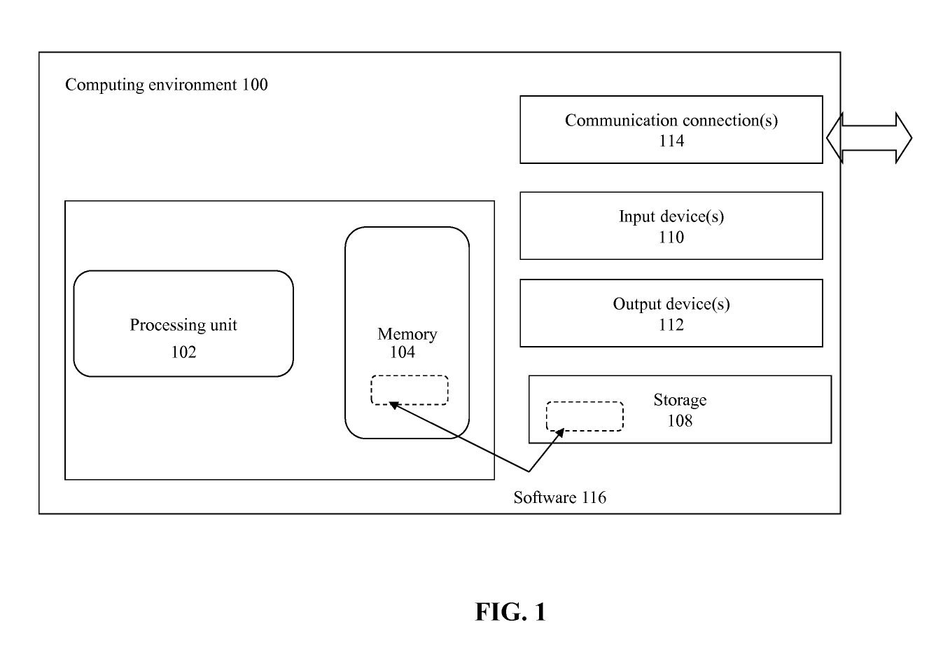

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

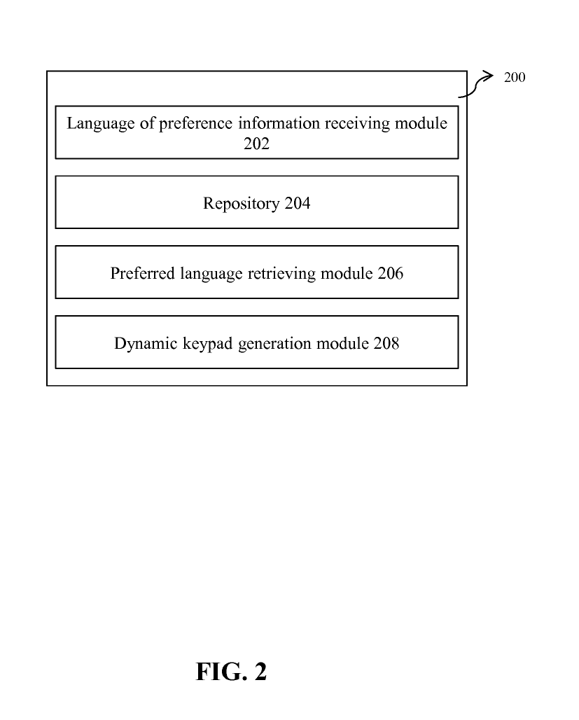

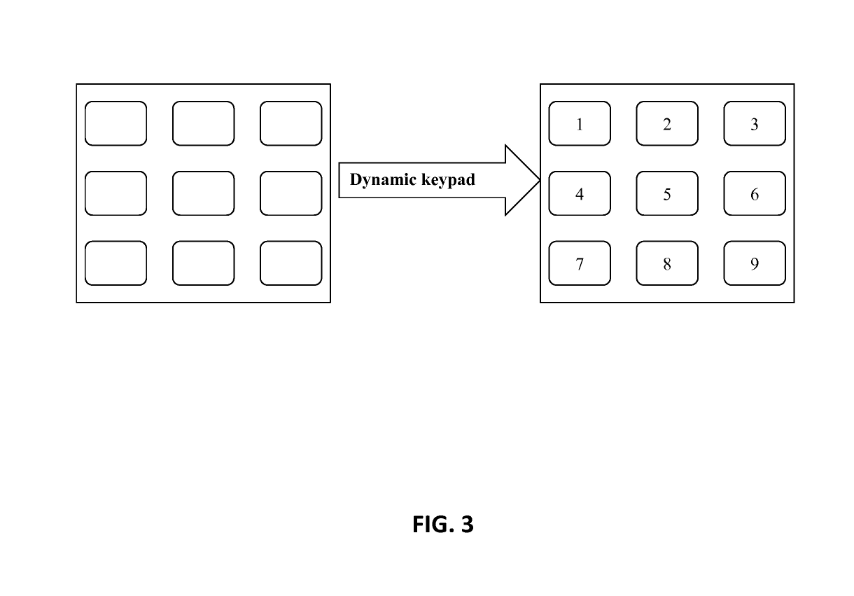

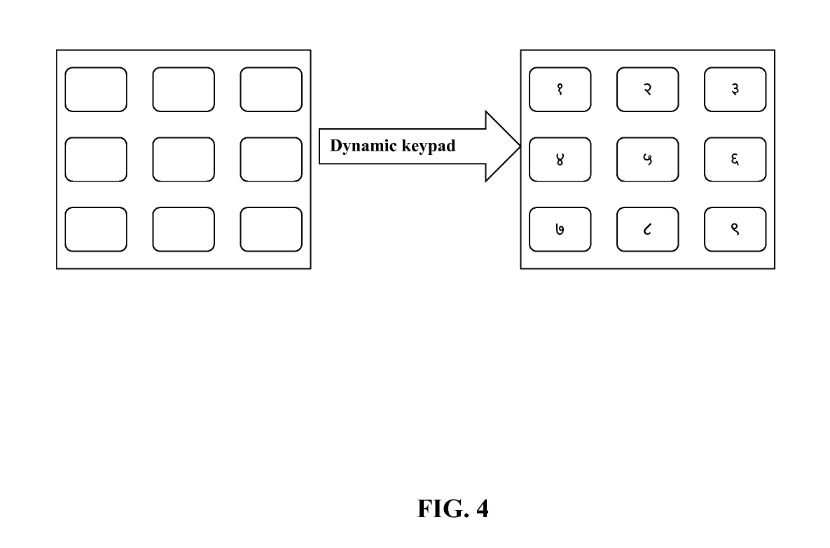

FIG. 2 is a block diagram illustrating a system 200 for generating a dynamic and localized keypad in an automated teller machine (ATM), in accordance with an embodiment of the present invention. More particularly, the system 200 includes a language of preference information receiving module 202, a repository 204, a preferred language retrieving module 206 and a dynamic keypad generation module 208. The language of preference information receiving module 202 receives the language of preference of the ATM users. In various embodiments of the present disclosure, the ATM machine receives the language of preference of the ATM users either from the ATM card inserted into the ATM machine or from a language choice made by the user while interacting with the ATM machine. The ATM machine has a default language set and if the language of preference information is not received by the ATM machine then, that default language is processed to continue the transaction. This information is passed to a mini computer that has the repository 204 which stores one or more different languages, the number symbols and additional texts and characters that are required to be displayed in the dynamic keypad. The layout of the keypad is predefined. The preferred language retrieving module 206 retrieves all the information required to generate the keypad from the repository 204. The dynamic keypad generation module 208 generates the dynamic keypad based on the predefined keypad layout and the preferred language and loads the keypad and loads the keypad on a touch sensitive display of the ATM machine. The keypad may have simple touch sensitive display or in an alternative embodiment, the keypad may be seen through one or more plastic keys with no text on them. A touch sensitive display may be situated below the plastic keys and when the dynamic keypad is loaded on the touch sensitive display then the numbers in preferred language can be seen through the plastic keys and the user can press the relevant keys to continue the transaction. FIG. 3 is an exemplary dynamically loaded keypad when the preferred language is English and FIG. 4 is an exemplary dynamically loaded keypad when the preferred language is Marathi. These figures are used for illustrative purpose only and not intended to limit the scope of the invention.

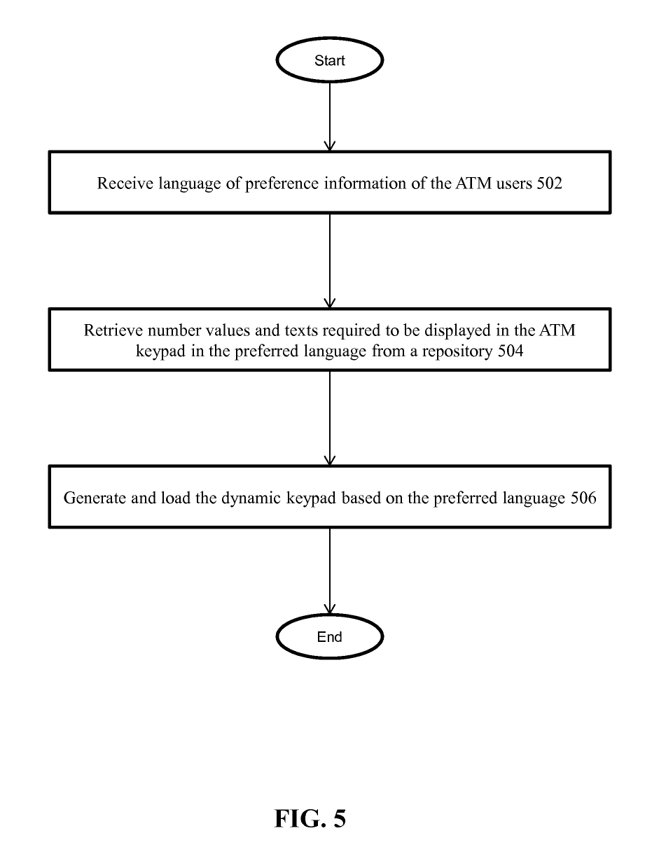

FIG. 5 is a flowchart, illustrating a method for generating a dynamic and localized keypad in an automated teller machine (ATM), in accordance with an embodiment of the present invention. The language of preference information is received from the ATM users, as in step 502. The language of preference is received from the inserted or swiped ATM card in the machine or from a language choice made by the user at the time of interaction with the ATM machine. If no language of preference information received then the default language is chosen by the ATM machine for continuing the transaction. This information is passed to a mini computer which has a repository of different languages along with the number symbols and other characters that are required to be displayed in the keypad. Based on that, all the required information is retrieved from the repository, as in step 504. After that, the dynamic keypad is generated based on a predefined keypad template and preferred language, as in step 506, and the keypad is loaded on a touch sensitive display of the ATM machine. The keypad may have simple touch sensitive display or in an alternative embodiment, the keypad may be seen through one or more plastic keys with no text on them. A touch sensitive display may be situated below the plastic keys and when the dynamic keypad is loaded on the touch sensitive display then the numbers in preferred language can be seen through the plastic keys and the user can press the relevant keys to continue the transaction.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A method, executed by one or more computing devices, for generating a dynamic and localized keypad in an automated teller machine (ATM), the said method comprising:
receiving information related to a language of preference of one or more ATM users for a transaction;
retrieving a plurality of number symbols and texts in the preferred language from a repository which are required to be displayed, wherein the repository stores one or more languages and a plurality of number symbols for the one or more languages; and
generating a dynamic keypad based on the preferred language, wherein the dynamic keypad is loaded on a touch sensitive display of the automated teller machine.

2. The method as claimed in claim 1 further includes loading a default keypad if no language preference is found.

3. The method as claimed in claim 1, wherein the language of preference of the one or more users is received either from a ATM card that contains language preference information or from a choice made by the one or more users during an interaction with the ATM.

4. The method as claimed in claim 1, wherein the dynamic keypad displays the plurality of number symbols or a combination of the plurality of number symbols and texts based on a keypad layout.

5. A system for creating a dynamic and localized keypad in an automated teller machine (ATM) comprising:
a processor in operable communication with a processor readable storage medium, the processor readable storage medium containing one or more programming instructions whereby the processor is configured to implement:
a language of preference information receiving module configured to receive information related to a language of preference of one or more ATM users for a transaction;
a repository configured to store one or more languages and a plurality of number symbols for the one or more languages;
a preferred language retrieving module configured to retrieve the plurality of number symbols and texts in the preferred language from the repository; and
a dynamic keypad generation module configured to generate a dynamic keypad based on the preferred language, wherein the dynamic keypad is loaded on a touch sensitive display of the automated teller machine.

6. The system as claimed in claim 5, wherein the language of preference of the one or more users is received either from a ATM card that contains language preference information or from a choice made by the one or more users during an interaction with the ATM.

7. The system as claimed in claim 5, wherein the dynamic keypad displays the plurality of number symbols or a combination of the plurality of number symbols and texts based on a keypad layout.

8. A computer program product for use with a computer, the computer program product comprising a computer readable medium having computer readable program code embodied therein for creating a dynamic and localized keypad in an automated teller machine (ATM), the computer readable program code storing a set of instructions configured for:
receiving information related to a language of preference of one or more ATM users for a transaction;
retrieving a plurality of number symbols and texts in the preferred language from a repository which are required to be displayed, wherein the repository stores one or more languages and a plurality of number symbols for the one or more languages; and
generating a dynamic keypad based on the preferred language, wherein the dynamic keypad is loaded on a touch sensitive display of the automated teller machine.

9. The computer program product as claimed in claim 8, wherein the language of preference of the one or more users is received either from a ATM card that contains language preference information or from a choice made by the one or more users during an interaction with the ATM.
